(19) United States
(12) Patent Application Publication
(10) Pub. No.: US 2021/0396961 A1
(43) Pub. Date: Dec. 23, 2021

(54) OPTICAL IMAGING SYSTEM, IMAGE CAPTURING APPARATUS, AND ELECTRONIC DEVICE

(71) Applicant: JIANGXI JINGCHAO OPTICAL CO., LTD., Nanchang (CN)

(72) Inventors: Han XIE, Nanchang (CN); Binbin LIU, Nanchang (CN); Ming LI, Nanchang (CN)

(21) Appl. No.: 17/462,746

(22) Filed: Aug. 31, 2021

Related U.S. Application Data
(63) Continuation of application No. PCT/CN2020/082208, filed on Mar. 30, 2020.

(51) Int. Cl. G02B 13/00; G02B 9/34; H04N 5/225

(52) U.S. Cl. CPC G02B 13/004; H04N 5/2254; G02B 9/34

(57) ABSTRACT

The disclosure provides an optical imaging system, an image capturing apparatus, and an electronic device. The optical imaging system of the disclosure includes from an object side to an image side: a first lens with a positive refractive power, a second lens with a refractive power, a third lens with a refractive power, and a fourth lens with a refractive power. The optical imaging system satisfying the following expression: TTL≤2.644 mm, where TTL represents a distance from an object-side surface of the first lens to an imaging surface along an optical axis.

### CROSS-REFERENCE TO RELATED APPLICATION (S)

This application is a continuation of International Application No. PCT/CN2020/082208, filed on Mar. 30, 2020, the disclosure of which is hereby incorporated by reference in its entirety.

### TECHNICAL FIELD

This disclosure relates to the technical field of optical imaging, and in particular to an optical imaging system, an image capturing apparatus, and an electronic device.

### BACKGROUND

With the development of face unlocking of mobile phones, auto-driving vehicles, man-machine interfaces and games, industrial machine vision and measurement, security monitoring and other technologies, people require such devices to have three-dimensional (3D) face recognition, object restoration, mobile payment, and other functions. The realization of these functions puts forward higher requirements on camera technology. Time of flight (TOF) imaging technology applied to the camera can well realize the 3D face recognition function of the camera and has good object restoration. However, the total length of the existing TOF imaging-based camera system is too long, which cannot meet the requirement on ultra-thin cameras.

### SUMMARY

To this end, embodiments of the disclosure provide an optical imaging system, which has a short total length and can well satisfy the requirement for ultra-thin cameras.

An image capturing apparatus using the above-described optical imaging system is also provided.

In addition, an electronic device using the above-described image capturing apparatus is also provided.

According to an embodiment of the present disclosure, an optical imaging system is provided. The optical imaging system includes in order from an object side to an image side: a first lens with a positive refractive power, a second lens with a refractive power, a third lens with a refractive power, and a fourth lens with a refractive power. The optical imaging system satisfies the following expression: TTL≤2.644 mm, where TTL represents a distance from an object-side surface of the first lens to an imaging surface along an optical axis.

In embodiments of the disclosure, a total length of the optical imaging system can be sufficiently compressed, which can well satisfy the requirement for ultra-thin cameras.

In one embodiment, the first lens has an object-side surface which is convex near the optical axis and an image-side surface which is concave near the optical axis. The object-side surface is convex near the optical axis, which facilitates convergence of light, such that the first lens may have the sufficient positive refractive power and therefore the total length of the optical imaging system can be shortened. The image-side surface cooperates with the object-side surface to converge light.

In one embodiment, the third lens has an object-side surface which is concave near the optical axis and an image-side surface which is convex near the optical axis. The image-side surface is convex near the optical axis, which can ensure an ability of the third lens to correct aberration.

In one embodiment, the fourth lens has an object-side surface which is convex near the optical axis and an image-side surface which is concave near the optical axis. The image-side surface is concave near the optical axis, which can facilitate correction of field curvature of the optical imaging system, suppress the excessive increase of an incidence angle of the chief ray of the off-axis field of view, and correct aberration of the off-axis field of view.

In one embodiment, at least one of an object-side surface or an image-side surface of the fourth lens has at least one inflection point. The inflection point can be used to correct aberration of the off-axis field of view, restrain an incidence angle of light to the imaging surface, and match with a photosensitive element more accurately.

In one embodiment, the optical imaging system satisfies the following expression: 0.8<tan(FOV/2)<1.0, where FOV represents a maximum angle of view of the optical imaging system.

When tan(FOV/2) is less than 0.8, the angle of view of the optical imaging system is too small to obtain an image in a wide range. At the same time, an effective focal power of the optical imaging system may become too long, which is unfavorable for compression of the length of lens. When 0.8<tan(FOV/2)<1.0, a capturing range of the optical imaging system can be expanded.

In one embodiment, the optical imaging system satisfies the following expression: FNO≤1.6, where FNO represents an F-number of the optical imaging system.

When FNO≤1.6, the optical imaging system has higher luminous flux, such that a relative brightness is higher.

In one embodiment, the optical imaging system satisfies the following expression: FNO≤1.3, where FNO represents an F-number of the optical imaging system.

When FNO≤1.3, the optical imaging system has higher luminous flux, such that a relative brightness is higher.

In one embodiment, the optical imaging system satisfies the following expressions: 19<Vd1<25; 19<Vd2<25; 19<Vd3<25; 19<Vd4<25, where Vd1 represents the Abbe number of the first lens, Vd2 represents the Abbe number of the second lens, Vd3 represents the Abbe number of the third lens, and Vd4 represents the Abbe number of the fourth lens.

When each of Vd1, Vd2, Vd3, and Vd4 is greater than 19 and less than 25, the optical imaging system can obtain higher modulation transfer function, and the image quality of the optical imaging system can be improved.

In one embodiment, the optical imaging system satisfies the following expression: 0.5<CT2/CT3<1.5, where CT2 represents a center thickness of the second lens, and CT3 represents a center thickness of the third lens.

When 0.5<CT2/CT3<1.5, the optical imaging system can be stably assembled.

In one embodiment, the optical imaging system satisfies the following expression: 0<R5/R6<2.2, where R5 represents a radius of curvature of an object-side surface of the second lens at the optical axis, and R6 represents a radius of curvature of an image-side surface of the second lens at the optical axis.

When 0<R5/R6<2.2, the object-side surface and the image-side surface of the second lens may have a similar shape and may be formed more uniformly. Moreover, the object-side surface and the image-side surface are curved towards a same side, which facilitates to improve resolution of the optical imaging system.

In one embodiment, the optical imaging system satisfies the following expression: 0.18<R7/R8<1.1, where R7 represents a radius of curvature of an object-side surface of the third lens at the optical axis, and R8 represents a radius of curvature of an image-side surface of the third lens at the optical axis.

When 0.18<R7/R8<1.1, the object-side surface and the image-side surface of the third lens may have a similar shape and may be formed more uniformly. Moreover, the object-side surface and the image-side surface are curved towards a same side, which facilitates to improve resolution of the optical imaging system.

In one embodiment, the optical imaging system satisfies the following expression: 0.4<R10/f<0.8, where R10 represents a radius of curvature of an image-side surface of the fourth lens at the optical axis, and f represents an effective focal length of the optical imaging system.

When 0.4<R10/f<0.8, the image-side surface of the fourth lens is concave near the axis and convex at the circumference, which can facilitate correction of field curvature of the optical imaging system, suppress the excessive increase of an incidence angle of the chief ray of the off-axis field of view, and correct aberration of the off-axis field of view.

In one embodiment, the optical imaging system satisfies the following expression: −1<f1/f23<0.5, where f1 represents an effective focal length of the first lens, and f23 represents a composite focal length of the second lens and the third lens.

Most of the positive refractive power is provided by the first lens, and the refractive powers of the second lens and the third lens are appropriately configured. In this way, a positive spherical aberration generated by the first lens can be corrected, and a small part of the positive refractive power can be compensated for the optical imaging system. Therefore, the optical imaging system has a relatively high image quality.

Embodiments of the disclosure further provide an image capturing apparatus comprising the optical imaging system described above and a photosensitive element. The photosensitive element is disposed at the image side of the optical imaging system.

The image capturing apparatus of the disclosure has a small thickness and can be used for the ultra-thin camera.

The image capturing apparatus of the disclosure has a relatively wide focus range and a high image quality while ensuring a compact size.

Embodiments of the disclosure further provide an electronic device. The electronic device includes a main body and the image capturing apparatus described above. The image capturing apparatus is installed on the main body.

The electronic device of the disclosure has a camera with a small thickness, which facilitates to reduce the size of the electronic device.

As such, the optical imaging system of the disclosure has a total length less than or equal to 2.644 mm, which is short enough to meet the requirement for ultra-thin cameras.

### BRIEF DESCRIPTION OF THE DRAWINGS

In order to illustrate the structural features and effects of this disclosure more clearly, the disclosure will be described in the following in detail with reference to the accompanying drawings and detailed description.

FIG. 1A is a schematic structural diagram of an optical imaging system according to a first embodiment of the disclosure.

FIG. 1B illustrates from left to right the spherical aberration curve, the astigmatic curve, and the distortion curve of the optical imaging system according to the first embodiment of the disclosure.

FIG. 2A is a schematic structural diagram of an optical imaging system according to a second embodiment of the disclosure.

FIG. 2B illustrates from left to right the spherical aberration curve, the astigmatic curve, and the distortion curve of the optical imaging system according to the second embodiment of the disclosure.

FIG. 3A is a schematic structural diagram of an optical imaging system according to a third embodiment of the disclosure.

FIG. 3B illustrates from left to right the spherical aberration curve, the astigmatic curve, and the distortion curve of the optical imaging system according to the third embodiment of the disclosure.

FIG. 4A is a schematic structural diagram of an optical imaging system according to a fourth embodiment of the disclosure.

FIG. 4B illustrates from left to right the spherical aberration curve, the astigmatic curve, and the distortion curve of the optical imaging system according to the fourth embodiment of the disclosure.

FIG. 5A is a schematic structural diagram of an optical imaging system according to a fifth embodiment of the disclosure.

FIG. 5B illustrates from left to right the spherical aberration curve, the astigmatic curve, and the distortion curve of the optical imaging system according to the fifth embodiment of the disclosure.

FIG. 6A is a schematic structural diagram of an optical imaging system according to a sixth embodiment of the disclosure.

FIG. 6B illustrates from left to right the spherical aberration curve, the astigmatic curve, and the distortion curve of the optical imaging system according to the sixth embodiment of the disclosure.

FIG. 7 is a schematic structural diagram of an image capturing apparatus according to an embodiment of the disclosure.

FIG. 8 is a schematic structural diagram of an electronic device according to an embodiment of the disclosure.

### DETAILED DESCRIPTION

The technical solutions in the embodiments of the present disclosure will be clearly and completely described below in conjunction with the drawings in the embodiments of the present disclosure. Obviously, the described embodiments are merely a part rather than all of the embodiments of the present disclosure. Based on the embodiments in this disclosure, all other embodiments obtained by those of ordinary skill in the art without creative work shall fall within the protection scope of this disclosure.

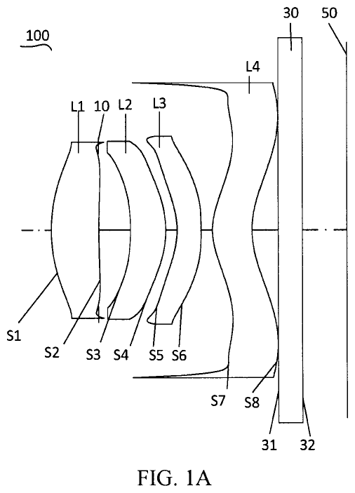

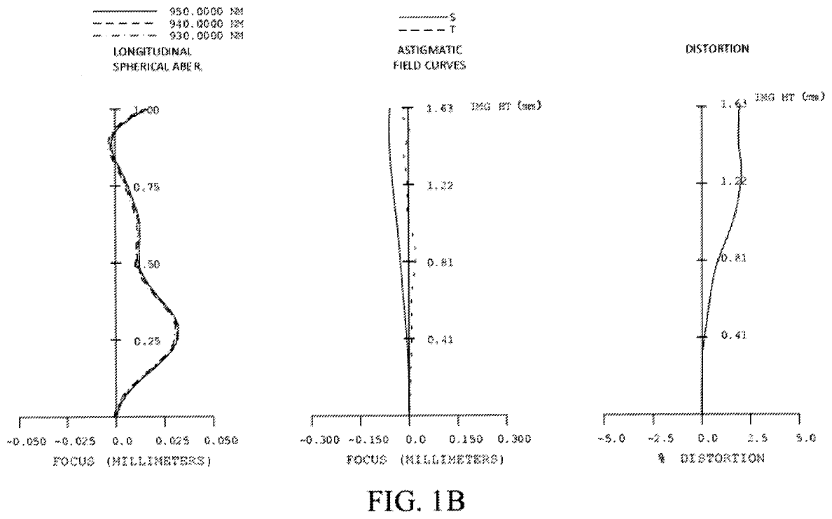

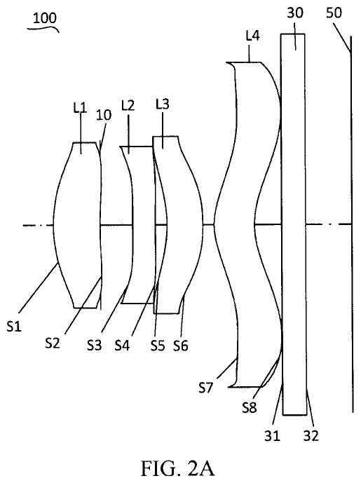

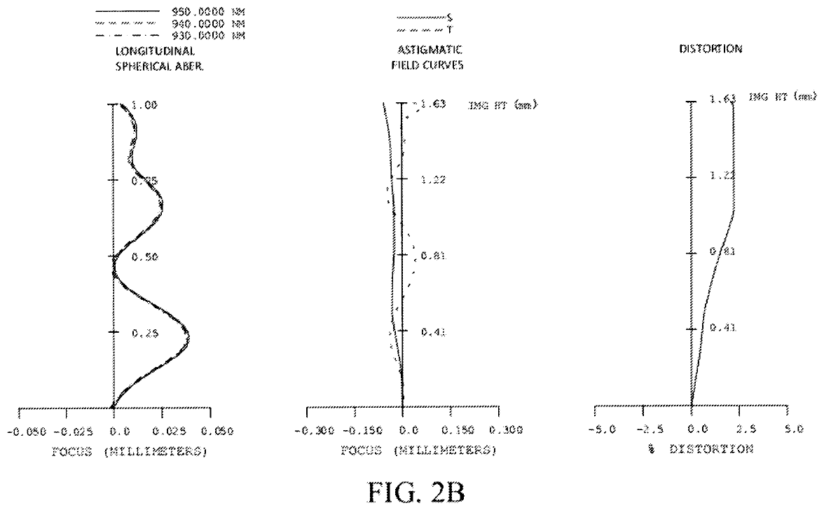

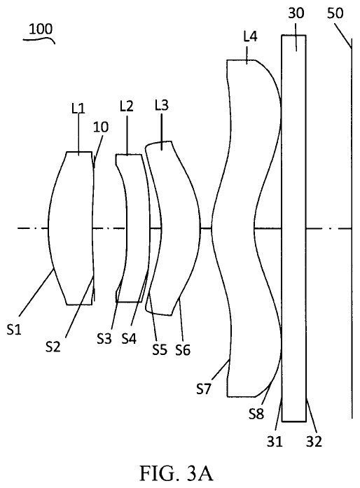

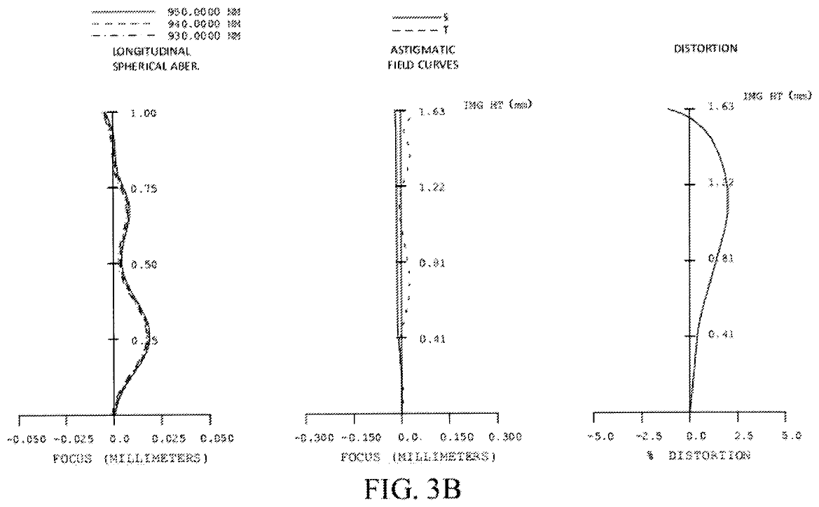

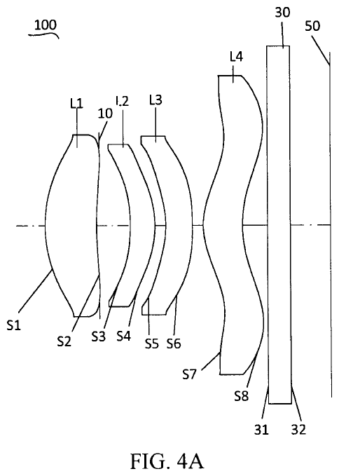

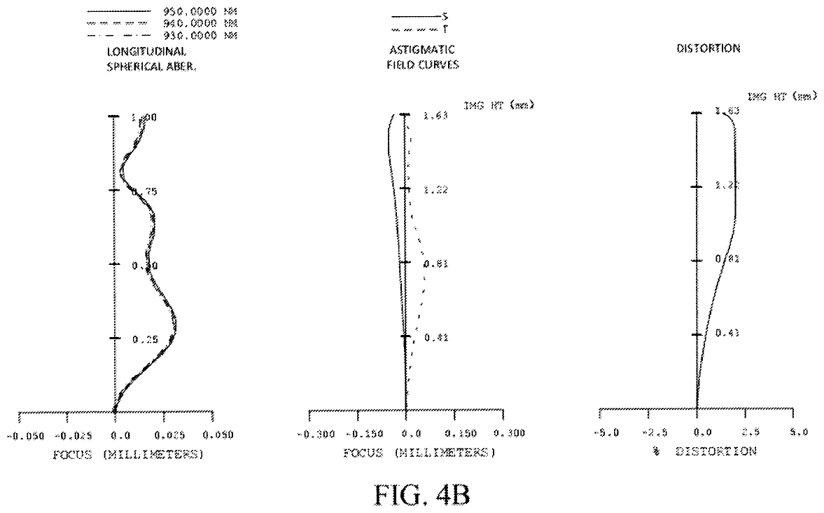

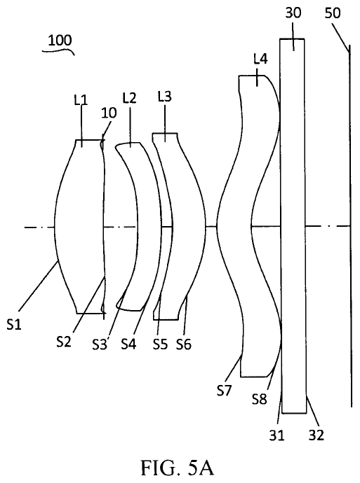

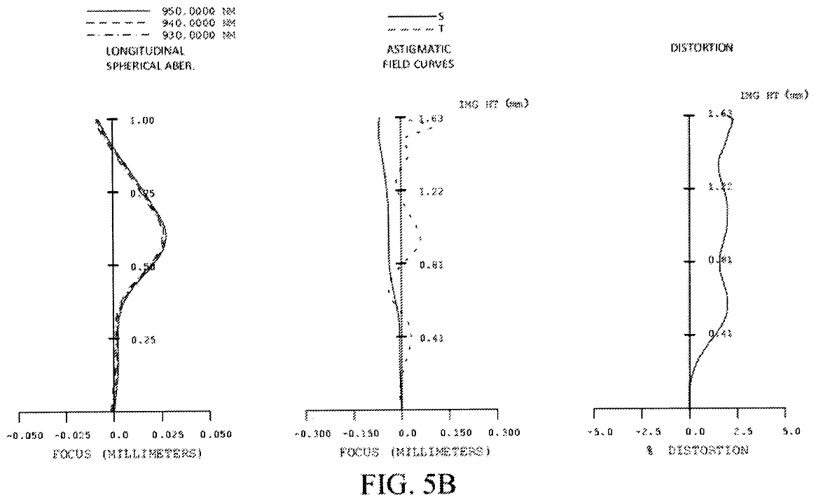

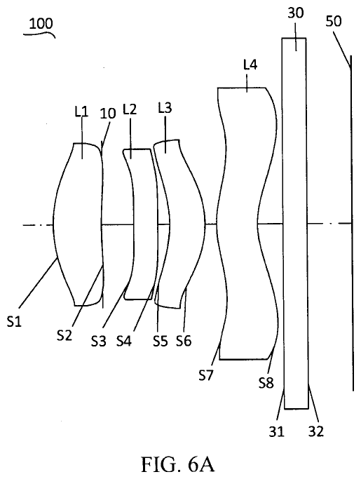

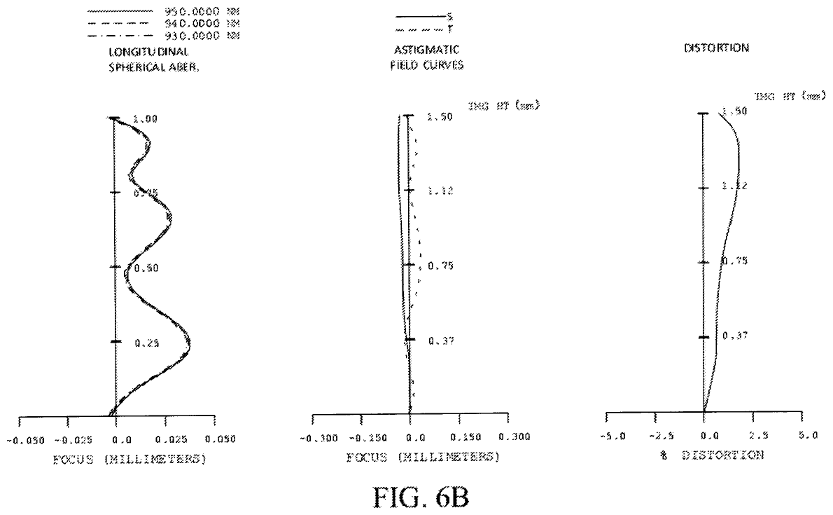

Referring to FIG. 1A, FIG. 2A, FIG. 3A, FIG. 4A, FIG. 5A, and FIG. 6A, an optical imaging system 100 of embodiments of the present disclosure is suitable for infrared (IR) band imaging, which is applicable to a lens of a computer, a mobile phone, a tablet computer, an in-vehicle device, a monitor, a security device, a medical equipment, a game machine, a robot, and other camera devices. The optical imaging system 100 includes, from an object side to an image side, a first lens L1 with a positive refractive power, a second lens L2 with a refractive power, a third lens L3 with a refractive power, a fourth lens L4 with a refractive power, and an imaging surface 50. The optical imaging system 100 satisfies the following expression:

TTL≤2.644 mm;

where TTL represents a distance from an object-side surface of the first lens L1 to the imaging surface 50 along an optical axis, that is, a total length of the optical imaging system 100.

In embodiments, TTL may be 2.3 mm, 2.35 mm, 2.4 mm, 2.45 mm, 2.5 mm, 2.55 mm, 2.6 mm, or 2.64 mm.

When TTL≤2.644 mm, the total length of the optical imaging system 100 can be sufficiently compressed, which can meet the requirement for ultra-thin cameras.

In this disclosure, the term “refractive power” (also referred to focal power) characterizes an ability of an optical system to deflect light.

In this disclosure, the total length of the optical imaging system 100 is less than 2.644 mm, which can meet the requirement for ultra-thin cameras.

In some embodiments, the first lens L1 is made of plastic or glass. The first lens L1 has an object-side surface S1 and an image-side surface S2. The object-side surface S1 is convex near the optical axis and may be convex or concave at the circumference. The image-side surface S2 is concave near the optical axis and may be convex or concave at the circumference. The object-side surface S1 is convex near the optical axis, which facilitates convergence of light, such that the first lens L1 has a sufficient positive refractive power and therefore the total length of the optical imaging system 100 can be shortened. The image-side surface S2 cooperates with the object-side surface to converge light.

In some embodiments, the second lens L2 is made of plastic or glass. The second lens L2 has an object-side surface S3 and an image-side surface S4. The second lens L2 may have a positive refractive power or a negative refractive power. The object-side surface S3 may be convex or concave near the optical axis, and may be convex or concave at the circumference. The image-side surface S4 may be convex or concave near the optical axis, and may be convex or concave at the circumference.

In some embodiments, the third lens L3 is made of plastic or glass. The third lens L3 has an object-side surface S5 and an image-side surface S6. The third lens L3 may have a positive refractive power or a negative refractive power. The object-side surface S5 is concave near the optical axis, and may be convex or concave at the circumference. The image-side surface S6 is convex near the optical axis, and may be convex or concave at the circumference. The image-side surface S6 of the third lens L3 is convex near the optical axis, which can ensure the ability of aberration correction of the third lens.

In some embodiments, the fourth lens L4 is made of plastic or glass. The fourth lens L4 has an object-side surface S7 and an image-side surface S8. The fourth lens L4 may have a positive refractive power or a negative refractive power. The object-side surface S7 is convex near the optical axis, and may be convex or concave at the circumference. The image-side surface S8 is concave near the optical axis, and may be convex or concave at the circumference. When the image-side surface S8 of the fourth lens L4 is concave near the optical axis and convex at the circumference, it can facilitate correction of field curvature of the optical imaging system 100, suppress the excessive increase of an incidence angle of the chief ray of the off-axis field of view, and correct aberration of the off-axis field of view.

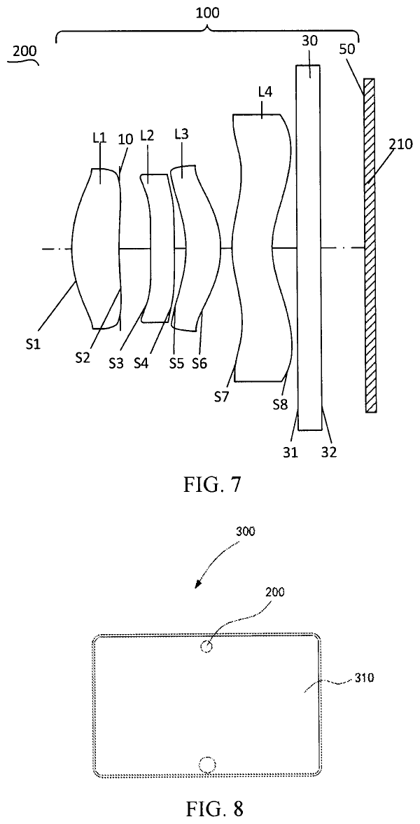

In some embodiments, at least one of the object-side surface S7 and the image-side surface S8 of the fourth lens L4 has at least one inflection point. The term “inflection point” refers to an inflexion where a radius of curvature turns form positive to negative or turns from negative to positive. The inflection point can be used to correct aberration of the off-axis field of view, restrain an incidence angle of light to the imaging surface 50, and match with a photosensitive element more accurately (referring to FIG. 7 and embodiments below for details).

In some embodiments, some or all the first lens L1, the second lens L2, the third lens L3, and the fourth lens L4 may be made of glass or plastic. For example, the first lens L1 is a glass lens, and the second lens L2, the third lens L3, and the fourth lens L4 are plastic lenses. The first lens L1 closest to the object side is glass lens, which can withstand the effect of environment temperature at the object side. At the same time, the second lens L2, the third lens L3, and the fourth lens L4 are plastic lenses, which can reduce the weight of the optical imaging system 100 and reduce production cost. Further, compared to an optical imaging system including plastic lenses only, the optical imaging system 100 including plastic lens and glass lens has a higher light transmittance and more stable chemical properties, which can improve the image quality under different light and dark contrast.

In some embodiments, the first lens L1, the second lens L2, the third lens L3, and the fourth lens L4 are aspheric lenses. The aspheric lenses facilitate correction of aberration of the optical imaging system 100 and improve image quality of the optical imaging system 100. The lens can be easily formed into a shape other than a spherical surface, so as to obtain more control variables and obtain a good quality with a small number of lenses. In this way, the number of lenses can be reduced to enable miniaturization. The term “aspheric lens” refers to a lens with at least one aspheric surface.

In some embodiments, for each of the first lens L1, the second lens L2, the third lens L3, and the fourth lens L4, if the object-side surface and/or the image-side surface of the lens are aspheric surfaces, the aspheric surfaces each satisfy the following expression:

$$Z = \frac{c {r}^{2}}{1 + \sqrt{1 - ( k + 1 ) {c}^{2} {r}^{2}}} + {\sum }_{i} A i {r}^{i}$$

Where Z represents a distance from a respective point on the aspheric surface to a plane tangent to a vertex of the object-side surface or the image-side surface, r represents a distance from a respective point on the aspheric surface to the optical axis, c represents a radius of curvature of a vertex of the aspheric surface (at the optical axis), k represents the conic coefficient, and Ai represents the aspheric coefficient of order i of the object-side surface or the image-side surface.

In one example, the optical imaging system 100 further includes a stop 10. The stop 10 may be located between the object side of the first lens L1 and the object-side surface S8 of the fourth lens L4. For example, the stop 10 is located between the first lens L1 and the second lens L2, which facilitates to increase the angle of view of the optical imaging system 100. The stop 10 may be located at any location between the object side of the first lens L1 and the object-side surface S8 of the fourth lens L4. The location of the stop 10 is not limited in the disclosure.

In one example, the optical imaging system 100 further includes an infrared band-pass filter 30. The infrared band-pass filter 30 is located between the fourth lens L4 and the imaging surface 50. The infrared band-pass filter 30 has a first surface 31 and the second surface 32. The infrared band-pass filter 30 is made of glass, which can increase transmittance of light in infrared band and allow the optical imaging system 100 to be better used for infrared imaging.

The term “ghost image” in this disclosure is also called ghosting image, which refers to an additional image generated near the focal plane of the optical imaging system due to the reflection on the lens surface. The brightness of the ghost image is generally darker and is offset from the original image.

In some embodiments, the optical imaging system 100 satisfies the following expression: 0.8<tan(FOV/2)<1.0, where FOV represents a maximum angle of view of the optical imaging system 100. That is, tan(FOV/2) may take any value between 0.8 and 1.0, such as: 0.81, 0.85, 0.90, 0.95, 0.99, etc.

When tan(FOV/2) is less than 0.8, the angle of view of the optical imaging system 100 is too small to obtain an image in a wide range. At the same time, an effective focal power of the optical imaging system 100 may become longer, which is unfavorable for compression of the length of lens. When 0.8<tan(FOV/2)<1.0, a capturing range of the optical imaging system 100 can be expanded.

In some embodiments, the optical imaging system 100 satisfies the following expression: FNO≤1.6, where FNO represents an F-number of the optical imaging system 100. That is, FNO may take any value less than or equal to 1.6, such as: 1.0, 1.1, 1.2, 1.3, 1.4, 1.5, 1.6, etc.

When FNO≤1.6, the optical imaging system 100 has a higher luminous flux, such that a relative brightness is higher.

In some embodiments, the optical imaging system 100 satisfies the following expression: FNO≤1.3, where FNO represents an F-number of the optical imaging system 100. That is, FNO may take any value less than or equal to 1.3, such as: 0.91, 0.95, 1.0, 1.1, 1.2, 1.3, etc.

When FNO≤1.3, the optical imaging system 100 has a higher luminous flux, such that a relative brightness is higher.

In some embodiments, the optical imaging system 100 satisfies the following expressions: 19<Vd1<25; 19<Vd2<25; 19<Vd3<25; 19<Vd4<25, where Vd1 represents the Abbe number of the first lens, Vd2 represents the Abbe number of the second lens, Vd3 represents the Abbe number of the third lens, and Vd4 represents the Abbe number of the fourth lens. That is, Vd1, Vd2, Vd3, and Vd4 may take any value between 19 and 25, such as: 19.1, 20, 21, 22, 23, 24, 24.9, etc.

When each of Vd1, Vd2, Vd3, and Vd4 is greater than 19 and less than 25, the optical imaging system 100 can obtain a higher modulation transfer function, and the image quality of the optical imaging system 100 can be improved.

The term “modulation transfer function” in this disclosure is also referred to as spatial contrast transfer function or spatial frequency contrast sensitivity function. The modulation transfer function reflects the ability of the optical imaging system 100 to transfer a modulation depth of an object in various frequencies. The higher the modulation transfer function of the optical imaging system 100, the better the image quality.

In some embodiments, the optical imaging system 100 satisfies the following expression: 0.5<CT2/CT3<1.5, where CT2 represents a center thickness of the second lens L2, that is, a distance from the object-side surface S3 to the image-side surface S4 of the second lens L2 along the optical axis, and CT3 represents a center thickness of the third lens L3, that is, a distance from the object-side surface S5 to the image-side surface S6 of the third lens L3 along the optical axis. That is, CT2/CT3 may take any value between 0.5 and 1.5, such as: 0.51, 0.6, 0.7, 0.8, 0.85, 0.9, 0.95, 1.0, 1.04, 1.2, 1.3, 1.49, etc.

When 0.5<CT2/CT3<1.5, the optical imaging system 100 can be stably assembled.

In some embodiments, the optical imaging system 100 satisfies the following expression: 0<R5/R6<2.2, where R5 represents a radius of curvature of an object-side surface S3 of the second lens L2 at the optical axis, and R6 represents a radius of curvature of an image-side surface S4 of the second lens L2 at the optical axis. That is, R5/R6 may take any value between 0 and 2.2, such as: 0.1, 0.6, 0.8, 1.0, 1.5, 2.0, 2.1, 2.19, etc.

When 0<R5/R6<2.2, an object-side surface S3 and an image-side surface S4 of the second lens L2 may have a similar shape and may be formed more uniformly. Moreover, the object-side surface S3 and the image-side surface S4 are curved towards a same side, which facilitates to improve resolution of the optical imaging system 100.

In some embodiments, the optical imaging system 100 satisfies the following expression: 0.18<R7/R8<1.1, where R7 represents a radius of curvature of an object-side surface S5 of the third lens L3 at the optical axis, and R8 represents a radius of curvature of an image-side surface S6 of the third lens L3 at the optical axis. That is, R7/R8 may take any value between 0.18 and 1.1, such as: 0.3, 0.5, 0.6, 0.8, 0.9, 1.0, 1.09, etc.

When 0.18<R7/R8<1.1, an object-side surface S5 and an image-side surface S6 of the third lens L3 may have a similar shape and may be formed more uniformly. Moreover, the object-side surface S5 and the image-side surface S6 are curved towards a same side, which facilitates to improve resolution of the optical imaging system 100.

In some embodiments, the optical imaging system 100 satisfies the following expression: 0.4<R10/f<0.8, where R10 represents a radius of curvature of an image-side surface S8 of the fourth lens L4 at the optical axis, and f represents an effective focal length of the optical imaging system 100. That is, R10/f may take any value between 0.4 and 0.8, such as: 0.41, 0.5, 0.6, 0.7, 0.79, etc.

When 0.4<R10/f<0.8, the image-side surface S8 of the fourth lens L4 is concave near the optical axis and convex at the circumference, which can facilitate correction of field curvature of the optical imaging system 100, suppress the excessive increase of an incidence angle of the chief ray of the off-axis field of view, and correct aberration of the off-axis field of view.

In some embodiments, the optical imaging system 100 satisfies the following expression: −1<f1/f23<0.5, where f1 represents an effective focal length of the first lens L1, and f23 represents a composite focal length of the second lens L2 and the third lens L3. That is, f1/f23 may take any value between −1 and 0.5, such as: −0.99, −0.8, −0.5, −0.1, 0.1, 0.2, 0.3, 0.49, etc.

Most of the positive refractive power is provided by the first lens L1, and the refractive powers of the second lens L2 and the third lens L3 are appropriately configured. In this way, a positive spherical aberration generated by the first lens L1 can be corrected, and a small part of the positive refractive power can be compensated for the optical imaging system 100. Therefore, the optical imaging system 100 has a relatively high image quality.

### First Embodiment

Referring to FIG. 1A and FIG. 1B, FIG. 1A is a schematic structural diagram of an optical imaging system 100 according to the first embodiment, and FIG. 1B illustrates from left to right the spherical aberration curve, the astigmatic curve, and the distortion curve of the first embodiment of the disclosure. As can be seen from FIG. 1A, the optical imaging system 100 of the first embodiment includes, from an object side to an image side, a first lens L1 with a positive refractive power, a stop 10, a second lens L2 with a positive refractive power, a third lens L3 with a negative refractive power, a fourth lens L4 with a positive refractive power, an infrared band-pass filter 30, and an imaging surface 50.

The first lens L1 is made of plastic and has an object-side surface S1 and an image-side surface S2. The object-side surface S1 is convex near an optical axis and concave at the circumference. The image-side surface S2 is concave near the optical axis and convex at the circumference.

The second lens L2 is made of plastic and has an object-side surface S3 and an image-side surface S4. The object-side surface S3 is concave both near an optical axis and at the circumference. The image-side surface S4 is convex both near the optical axis and at the circumference.

The third lens L3 is made of plastic and has an object-side surface S5 and an image-side surface S6. The object-side surface S5 is concave both near an optical axis and at the circumference. The image-side surface S6 is convex both near the optical axis and at the circumference.

The fourth lens L4 is made of plastic and has an object-side surface S7 and an image-side surface S8. The object-side surface S7 is convex both near an optical axis and at the circumference. The image-side surface S8 is concave near the optical axis and convex at the circumference.

In this embodiment, TTL=2.63 mm; FOV=86.68°, tan(FOV/2)=0.944; FNO=1.2; CT2=0.314, CT3=0.215; CT2/CT3=1.460; R5=−1.808, R6=−0.849, R5/R6=2.130; R7=−0.677, R8=−3.857, R7/R8=0.176; R10=0.813, f=1.691, R10/f=0.481; f1=2.61, f23=−3.21, f1/f23=−0.813.

In this embodiment, the optical imaging system 100 satisfies conditions shown in Table 1 and Table 2 below.

TABLE 1
First embodiment
f = 1.691 mm, FNO = 1.2, FOV = 86.68°, TTL = 2.63 mm

| Surface | Surface | Surface | Y | | | Refractive | Abbe | Focal |
|---|---|---|---|---|---|---|---|---|
| number | name | type | radius | Thickness | Material | index | number | length |
| Object | | spheric | Infinity | 1020.13 | | | | |
| side | | | | | | | | |
| surface | | | | | | | | |
| S1 | First lens | aspheric | 1.320 | 0.424 | plastic | 1.640 | 23.530 | 2.61 |
| S2 | | aspheric | 6.444 | −0.003 | | | | |
| Stop | | spheric | Infinity | 0.286 | | | | |
| S3 | Second | aspheric | −1.808 | 0.314 | plastic | 1.661 | 20.370 | 2.24 |
| S4 | lens | aspheric | −0.849 | 0.100 | | | | |
| S5 | Third lens | aspheric | −0.677 | 0.215 | plastic | 1.640 | 23.530 | −1.37 |
| S6 | | aspheric | −3.857 | 0.100 | | | | |
| S7 | Fourth | aspheric | 0.523 | 0.353 | plastic | 1.640 | 23.530 | 1.62 |
| S8 | lens | aspheric | 0.813 | 0.233 | | | | |
| 31 | Infrared | spheric | Infinity | 0.214 | glass | 1.517 | 64.167 | |
| 32 | band-pass | spheric | Infinity | 0.394 | | | | |
| | filter | | | | | | | |
| Imaging | | spheric | Infinity | 0.000 | | | | |
| surface | | | | | | | | |

Note:
an IR wavelength of 940 nm is used as a reference wavelength during the test procedure of the embodiment of the disclosure

TABLE 2
Aspheric coefficients of the first embodiment

| Surface | | | | | | | | |
|---|---|---|---|---|---|---|---|---|
| number | S1 | S2 | S3 | S4 | S5 | S6 | S7 | S8 |
| K | −9.7787E−01 | −9.9000E+01 | −9.9000E+01 | −1.1584E+01 | −6.1536E−01 | 7.3728E+00 | −4.9727E | −1.5480E+00 |
| A4 | −1.3617E−01 | 1.5804E−01 | −2.3678E+00 | −1.8397E+00 | 1.5734E+00 | −3.6814E+00 | −6.4323E−01 | −4.2527E−01 |
| A6 | 1.3719E+00 | −5.4763E+00 | 2.1726E+01 | 1.4172E+01 | −1.3861E+00 | 3.0098E+01 | 3.4965E+00 | −3.4741E−01 |
| A8 | −3.2946E+00 | 6.4899E+01 | −2.1725E+02 | −9.4204E+01 | −4.4168E+00 | −1.6955E+02 | −1.5702E+01 | 2.2950E+00 |
| A10 | −3.8864E+01 | −4.8065E+02 | 1.5479E+03 | 4.7307E+02 | −1.2316E+01 | 6.5320E+02 | 4.1114E+01 | −5.0871E+00 |
| Al2 | 3.3226E+02 | 2.2331E+03 | −7.2583E+03 | −1.5895E+03 | 3.2759E+02 | −1.7077E+03 | −6.6718E+01 | 6.8075E+00 |
| A14 | −1.1563E+03 | −6.5823E+03 | 2.2085E+04 | 3.4896E+03 | −1.5604E+03 | 2.9637E+03 | 6.8272E+01 | −5.8072E+00 |
| A16 | 2.1065E+03 | 1.1946E+04 | −4.1991E+04 | −4.8468E+03 | 3.4930E+03 | −3.2445E+03 | −4.2786E+01 | 3.0673E+00 |
| A18 | −1.9747E+03 | −1.2167E+04 | 4.5263E+04 | 3.8464E+03 | −3.8990E+03 | 2.0124E+03 | 1.4982E+01 | −9.1077E−01 |
| A20 | 7.5066E+02 | 5.3158E+03 | −2.1110E+04 | −1.3219E+03 | 1.7447E+03 | −5.3411E+02 | −2.2438E+00 | 1.1595E−01 |

Table 2 shows the aspheric coefficients of the first embodiment, where k represents conic coefficients of respective surfaces, and A4-A20 represent the aspheric coefficients of orders 4-20 of respective surfaces.

As can be seen from FIG. 1A and FIG. 1B, the optical imaging system 100 of the embodiment has relatively high image quality while satisfying a compact size.

### Second Embodiment

Referring to FIG. 2A and FIG. 2B, FIG. 2A is a schematic structural diagram of an optical imaging system 100 according to the second embodiment, and FIG. 2B illustrates from left to right the spherical aberration curve, the astigmatic curve, and the distortion curve of the second embodiment of the disclosure. As can be seen from FIG. 2A, the optical imaging system 100 of the second embodiment includes, from an object side to an image side, a first lens L1 with a positive refractive power, a stop 10, a second lens L2 with a negative refractive power, a third lens L3 with a negative refractive power, a fourth lens L4 with a positive refractive power, an infrared band-pass filter 30, and an imaging surface 50.

The first lens L1 is made of plastic and has an object-side surface S1 and an image-side surface S2. The object-side surface S1 is convex both near an optical axis and at the circumference. The image-side surface S2 is concave near the optical axis and convex at the circumference.

The second lens L2 is made of plastic and has an object-side surface S3 and an image-side surface S4. The object-side surface S3 is convex near an optical axis and concave at the circumference. The image-side surface S4 is concave near the optical axis and convex at the circumference.

The third lens L3 is made of plastic and has an object-side surface S5 and an image-side surface S6. The object-side surface S5 is concave both near an optical axis and at the circumference. The image-side surface S6 is convex both near the optical axis and at the circumference.

The fourth lens L4 is made of plastic and has an object-side surface S7 and an image-side surface S8. The object-side surface S7 is convex near an optical axis and concave at the circumference. The image-side surface S8 is concave near the optical axis and convex at the circumference.

In this embodiment, TTL=2.63 mm; FOV=82.7°, tan(FOV/2)=0.880; FNO=1.40; CT2=0.2, CT3=0.315; CT2/CT3=0.635; R5=7.766, R6=6.85, R5/R6=1.134; R7=−0.998, R8=−1.78, R7/R8=0.561; R10=0.748, f=1.81, R10/f=0.413; f1=2.46, f23=−4.22, f1/f23=−0.583.

In this embodiment, the optical imaging system 100 satisfies conditions shown in Table 3 and Table 4 below.

TABLE 3
Second embodiment
f = 1.81 mm, FNO = 1.4, FOV = 82.7°, TTL = 2.63 mm

| Surface | Surface | Surface | Y | | | Refractive | Abbe | Focal |
|---|---|---|---|---|---|---|---|---|
| number | name | type | radius | Thickness | Material | index | number | length |
| Object | | spheric | Infinity | 1000.00 | | | | |
| side | | | | | | | | |
| surface | | | | | | | | |
| S1 | First lens | aspheric | 1.201 | 0.413 | plastic | 1.640 | 23.530 | 2.46 |
| S2 | | aspheric | 4.979 | 0.003 | | | | |
| Stop | | | Infinity | 0.284 | | | | |
| S3 | Second | aspheric | 7.766 | 0.200 | plastic | 1.661 | 20.370 | −100.00 |
| S4 | lens | aspheric | 6.850 | 0.103 | | | | |
| S5 | Third lens | aspheric | −0.998 | 0.315 | plastic | 1.640 | 23.530 | −4.36 |
| S6 | | aspheric | −1.780 | 0.100 | | | | |
| S7 | Fourth | aspheric | 0.570 | 0.356 | plastic | 1.640 | 23.530 | 2.21 |
| S8 | lens | aspheric | 0.748 | 0.238 | | | | |
| 31 | Infrared | spheric | Infinity | 0.210 | glass | 1.517 | 64.167 | |
| 32 | band-pass | spheric | Infinity | 0.407 | | | | |
| | filter | | | | | | | |
| Imaging | | spheric | Infinity | 0.000 | | | | |
| surface | | | | | | | | |

Note:
an IR wavelength of 940 nm is used as a reference wavelength during the test procedure of the embodiment of the disclosure

TABLE 4
Aspheric coefficients of the second embodiment

| Surface | | | | | | | | |
|---|---|---|---|---|---|---|---|---|
| number | S1 | S2 | S3 | S4 | S5 | S6 | S7 | S8 |
| K | −1.1135E+00 | −9.9000E+01 | 5.3680E+01 | −9.0531E+01 | −3.1181E−02 | −3.2921E+01 | −6.8617E+00 | −1.9155E+00 |
| A4 | −1.8469E−01 | 2.5298E−01 | −2.5191E+00 | −1.5473E+00 | 2.5093E+00 | −3.4650E+00 | 8.5224E−02 | −4.5777E−01 |
| A6 | 3.9144E+00 | −8.8119E+00 | 4.6412E+01 | 2.1266E+01 | −3.8812E+01 | 2.7056E+01 | −8.5388E−01 | −1.7906E−01 |
| A8 | −4.2343E+01 | 1.1709E+02 | −6.3146E+02 | −1.7260E+02 | 4.5883E+02 | −1.6808E+02 | 8.3469E−01 | 2.0023E+00 |
| A10 | 2.7610E+02 | −9.6527E+02 | 5.0915E+03 | 8.0681E+02 | −3.2342E+03 | 7.6717E+02 | 1.5115E+00 | −4.4200E+00 |
| A12 | −1.1525E+03 | 4.9214E+03 | −2.5705E+04 | −2.3374E+03 | 1.3961E+04 | −2.4214E+03 | −5.0248E+00 | 5.4183E+00 |
| A14 | 3.0556E+03 | −1.5704E+04 | 8.1930E+04 | 4.2775E+03 | −3.7359E+04 | 5.0915E+03 | 6.0198E+00 | −4.0857E+00 |
| A16 | −4.9850E+03 | 3.0494E+04 | −1.5975E+05 | −4.7228E+03 | 6.0591E+04 | −6.7351E+03 | −3.7306E+00 | 1.8737E+00 |
| A18 | 4.5518E+03 | −3.2890E+04 | 1.7388E+05 | 2.7680E+03 | −5.4624E+04 | 5.0361E+03 | 1.1848E+00 | −4.7762E−01 |
| A20 | −1.7802E+03 | 1.5080E+04 | −8.0951E+04 | −6.1620E+02 | 2.1002E+04 | −1.6169E+03 | −1.5248E−01 | 5.1699E−02 |

Table 4 shows the aspheric coefficients of the second embodiment, where k represents conic coefficients of respective surfaces, and A4-A20 represent the aspheric coefficients of orders 4-20 of respective surfaces.

As can be seen from FIG. 2A and FIG. 2B, the optical imaging system 100 of the embodiment has relatively high image quality while satisfying a compact size.

### Third Embodiment

Referring to FIG. 3A and FIG. 3B, FIG. 3A is a schematic structural diagram of an optical imaging system 100 according to the third embodiment, and FIG. 3B illustrates from left to right the spherical aberration curve, the astigmatic curve, and the distortion curve of the third embodiment of the disclosure. As can be seen from FIG. 3A, the optical imaging system 100 of the second embodiment includes, from an object side to an image side, a first lens L1 with a positive refractive power, a stop 10, a second lens L2 with a positive refractive power, a third lens L3 with a positive refractive power, a fourth lens L4 with a positive refractive power, an infrared band-pass filter 30, and an imaging surface 50.

The first lens L1 is made of plastic and has an object-side surface S1 and an image-side surface S2. The object-side surface S1 is convex both near an optical axis and at the circumference. The image-side surface S2 is concave near the optical axis and convex at the circumference.

The second lens L2 is made of plastic and has an object-side surface S3 and an image-side surface S4. The object-side surface S3 is concave both near the optical axis and at the circumference. The image-side surface S4 is convex both near the optical axis and at the circumference.

The third lens L3 is made of plastic and has an object-side surface S5 and an image-side surface S6. The object-side surface S5 is concave both near the optical axis and at the circumference. The image-side surface S6 is convex both near the optical axis and at the circumference.

The fourth lens L4 is made of plastic and has an object-side surface S7 and an image-side surface S8. The object-side surface S7 is convex near the optical axis and concave at the circumference. The image-side surface S8 is concave near the optical axis and convex at the circumference.

In this embodiment, TTL=2.644 mm; FOV=85°, tan(FOV/2)=3.916; FNO=1.60; CT2=3.2, CT3=0.339; CT2/CT3=0.590; R5=−9.032, R6=−7.493, R5/R6=1.205; R7=−0.954, R8=−1.067, R7/R8=0.894; R10=0.747, f=−1.797, R10/f=0.416; f1=2.49, f23=42.755, f1/f23=0.058.

In this embodiment, the optical imaging system 100 satisfies conditions shown in Table 5 and Table 6 below.

TABLE 5
Third embodiment
f = 1.797 mm, FNO = 1.6, FOV = 85° , TTL = 2.644 mm

| Surface | Surface | Surface | Y | | | Refractive | Abbe | Focal |
|---|---|---|---|---|---|---|---|---|
| number | name | type | radius | Thickness | Material | index | number | length |
| Object | | spheric | Infinity | 1000.00 | | | | |
| side | | | | | | | | |
| surface | | | | | | | | |
| S1 | First lens | aspheric | 1.181 | 0.384 | plastic | 1.640 | 23.530 | 2.49 |
| S2 | | aspheric | 4.459 | 0.017 | | | | |
| Stop | | | Infinity | 0.286 | | | | |
| S3 | Second | aspheric | −9.032 | 0.200 | plastic | 1.661 | 20.370 | 65.98 |
| S4 | lens | aspheric | −7.493 | 0.100 | | | | |
| S5 | Third lens | aspheric | −0.954 | 0.339 | plastic | 1.640 | 23.530 | 100.00 |
| S6 | | aspheric | −1.067 | 0.100 | | | | |
| S7 | Fourth | aspheric | 0.721 | 0.370 | plastic | 1.640 | 23.530 | 5.25 |
| S8 | lens | aspheric | 0.747 | 0.238 | | | | |
| 31 | Infrared | spheric | Infinity | 0.210 | glass | 1.517 | 64.167 | |
| 32 | band-pass | spheric | Infinity | 0.400 | | | | |
| | filter | | | | | | | |
| Imaging | | spheric | Infinity | 0.000 | | | | |
| surface | | | | | | | | |

Note:
an IR wavelength of 940 nm is used as a reference wavelength during the test procedure of the embodiment of the disclosure

TABLE 6
Aspheric coefficients of the third embodiment

| Surface | | | | | | | | |
|---|---|---|---|---|---|---|---|---|
| number | S1 | S2 | S3 | S4 | S5 | S6 | S7 | S8 |
| K | −1.1978E+00 | −9.9000E+01 | −9.9000E+01 | 7.6106E+01 | −1.7768E−02 | −2.4487E+01 | −7.3676E+00 | −1.9771E+00 |
| A4 | −1.1107E−01 | −4.0552E−02 | −1.6783E+00 | −9.6568E−01 | 1.4671E+00 | −3.2862E+00 | 1.7053E−01 | −5.2160E−01 |
| A6 | 3.2618E+00 | 4.5021E−01 | 2.9060E+01 | 1.5209E+01 | −1.1591E+01 | 2.5246E+01 | −1.7027E+00 | 2.7058E−01 |
| A8 | −4.1803E+01 | −2.7927E+01 | −5.2316E+02 | −1.7725E+02 | 1.2481E+02 | −1.5672E+02 | 4.1066E+00 | 5.5211E−01 |
| A10 | 3.2138E+02 | 3.8024E+02 | 5.5212E+03 | 1.1930E+03 | −9.6509E+02 | 7.0366E+02 | −5.6839E+00 | −1.5974E+00 |
| Al2 | −1.5732E+03 | −3.0001E+03 | −3.6319E+04 | −4.8890E+03 | 4.8946E+03 | −2.1451E+03 | 4.6729E+00 | 1.9651E+00 |
| A14 | 4.8324E+03 | 1.4081E+04 | 1.4991E+05 | 1.2017E+04 | −1.5874E+04 | 4.3004E+03 | −2.0705E+00 | −1.4228E+00 |
| A16 | −9.0142E+03 | −3.8655E+04 | −3.7631E+05 | −1.6113E+04 | 3.1831E+04 | −5.3845E+03 | 3.3412E−01 | 6.2221E−01 |
| A18 | 9.2820E+03 | 5.6961E+04 | 5.2514E+05 | 8.9082E+03 | −3.5960E+04 | 3.7975E+03 | 5.8912E−02 | −1.5152E−01 |
| A20 | −4.0382E+03 | −3.4511E+04 | −3.1254E+05 | 2.2108E+02 | 1.7463E+04 | −1.1478E+03 | −2.0492E−02 | 1.5674E−02 |

Table 6 shows the aspheric coefficients of the third embodiment, where k represents conic coefficients of respective surfaces, and A4-A20 represent the aspheric coefficients of orders 4-20 of respective surfaces.

As can be seen from FIG. 3A and FIG. 3B, the optical imaging system 100 of the embodiment has relatively high image quality while satisfying a compact size.

### Fourth Embodiment

Referring to FIG. 4A and FIG. 4B, FIG. 4A is a schematic structural diagram of an optical imaging system 100 according to the fourth embodiment, and FIG. 4B illustrates from left to right the spherical aberration curve, the astigmatic curve, and the distortion curve of the third embodiment of the disclosure. As can be seen from FIG. 4A, the optical imaging system 100 of the second embodiment includes, from an object side to an image side, a first lens L1 with a positive refractive power, a stop 10, a second lens L2 with a positive refractive power, a third lens L3 with a negative refractive power, a fourth lens L4 with a positive refractive power, an infrared band-pass filter 30, and an imaging surface 50.

The first lens L1 is made of plastic and has an object-side surface S1 and an image-side surface S2. The object-side surface S1 is convex both near an optical axis and at the circumference. The image-side surface S2 is concave near the optical axis and convex at the circumference.

The second lens L2 is made of plastic and has an object-side surface S3 and an image-side surface S4. The object-side surface S3 is concave both near the optical axis and at the circumference. The image-side surface S4 is convex both near the optical axis and at the circumference.

The third lens L3 is made of plastic and has an object-side surface S5 and an image-side surface S6. The object-side surface S5 is concave both near the optical axis and at the circumference. The image-side surface S6 is convex near the optical axis and concave at the circumference.

The fourth lens L4 is made of plastic and has an object-side surface S7 and an image-side surface S8. The object-side surface S7 is convex near the optical axis and concave at the circumference. The image-side surface S8 is concave near the optical axis and convex at the circumference.

In this embodiment, TTL=2.63 mm; FOV=87.1°, tan(FOV/2)=0.951; FNO=1.08; CT2=0.228, CT3=0.245; CT2/CT3=0.931; R5=−1.826, R6=−0.942, R5/R6=1.938; R7=−0.878, R8=−4.688, R7/R8=0.187; R10=1.241, f=1.689, R10/f=0.735; f1=2.64, f23=−4.41, f1/f23=−0.599.

In this embodiment, the optical imaging system 100 satisfies conditions shown in Table 7 and Table 8 below.

TABLE 7
Fourth embodiment
f = 1.689 mm, FNO = 1.08, FOV = 87.1°, TTL = 2.63 mm

| Surface | Surface | Surface | | | | Refractive | Abbe | Focal |
|---|---|---|---|---|---|---|---|---|
| number | name | type | Y radius | Thickness | Material | index | number | length |
| Object | | spheric | Infinity | 1000.00 | | | | |
| side | | | | | | | | |
| surface | | | | | | | | |
| S1 | First lens | aspheric | 1.255 | 0.476 | plastic | 1.661 | 20.370 | 2.64 |
| S2 | | aspheric | 4.278 | 0.025 | | | | |
| [symbol] | | | Infinity | 0.284 | | | | |
| S3 | Second | aspheric | −1.826 | 0.228 | plastic | 1.661 | 20.370 | 2.79 |
| S4 | lens | aspheric | −0.942 | 0.100 | | | | |
| S5 | Third | aspheric | −0.878 | 0.245 | plastic | 1.660 | 20.400 | −1.75 |
| S6 | lens | aspheric | −4.688 | 0.100 | | | | |
| S7 | Fourth | aspheric | 0.655 | 0.363 | plastic | 1.660 | 20.400 | 1.77 |
| S8 | lens | aspheric | 1.241 | 0.229 | | | | |
| 31 | Infrared | spheric | Infinity | 0.210 | glass | 1.517 | 64.167 | |
| 32 | band-pass | spheric | Infinity | 0.369 | | | | |
| | filter | | | | | | | |
| Imaging | | spheric | Infinity | 0.000 | | | | |
| surface | | | | | | | | |

Note:
an IR wavelength of 940 nm is used as a reference wavelength during the test procedure of the embodiment of the disclosure

TABLE 8
Aspheric coefficients of the fourth embodiment

| Surface | | | | | | | | |
|---|---|---|---|---|---|---|---|---|
| number | S1 | S2 | S3 | S4 | S5 | S6 | S7 | S8 |
| K | −4.4662E−01 | −5.7288E+00 | −5.2768E+01 | −1.3570E+01 | −3.6273E−01 | 8.6025E+00 | −6.6074E+00 | 1.1671E+00 |
| A4 | −2.1296E−01 | −6.4240E−02 | −1.5042E+00 | −1.5107E+00 | 1.5342E+00 | −1.9811E+00 | 2.2739E−01 | 1.9457E−01 |
| A6 | 2.2369E+00 | 6.3021E−01 | 6.8505E+00 | 9.8449E+00 | −5.4819E+00 | 1.3867E+01 | −9.8396E−01 | −1.6818E+00 |
| A8 | −1.1879E+01 | −1.2251E+01 | −4.0356E+01 | −6.4196E+01 | 2.3035E+01 | −7.7739E+01 | 7.0758E−01 | 3.5191E+00 |
| A10 | 3.1567E+01 | 1.0425E+02 | 1.6473E+02 | 3.3285E+02 | −9.4231E+01 | 3.0455E+02 | 5.8750E−01 | −4.9152E+00 |
| Al2 | −2.7980E+01 | −5.0138E+02 | −2.8137E+02 | −1.1551E+03 | 3.0886E+02 | −8.1312E+02 | −1.7696E+00 | 4.8015E+00 |
| A14 | −5.8644E+01 | 1.4033E+03 | −2.7128E+02 | 2.5942E+03 | −7.1500E+02 | 1.4380E+03 | 1.8977E+00 | −3.1797E+00 |
| A16 | 1.7876E+02 | −2.2707E+03 | 1.9194E+03 | −3.6161E+03 | 1.0541E+03 | −1.6014E+03 | −1.1027E+00 | 1.3430E+00 |
| A18 | −1.7533E+02 | 1.9675E+03 | −2.9213E+03 | 2.8223E+03 | −8.7687E+02 | 1.0122E+03 | 3.3562E−01 | −3.2330E−01 |
| A20 | 6.1430E+01 | −7.0605E+02 | 1.5289E+03 | −9.3828E+02 | 3 .1153E+02 | −2.7494E+02 | −4.1699E−02 | 3.3527E−02 |

Table 8 shows the aspheric coefficients of the fourth embodiment, where k represents conic coefficients of respective surfaces, and A4-A20 represent the aspheric coefficients of orders 4-20 of respective surfaces.

As can be seen from FIG. 4A and FIG. 4B, the optical imaging system 100 of the embodiment has relatively high image quality while satisfying a compact size.

### Fifth Embodiment

Referring to FIG. 5A and FIG. 5B FIG. 5A is a schematic structural diagram of an optical imaging system 100 according to the fourth embodiment, and FIG. 5B illustrates from left to right the spherical aberration curve, the astigmatic curve, and the distortion curve of the third embodiment of the disclosure. As can be seen from FIG. 5A, the optical imaging system 100 of the fourth embodiment includes, from an object side to an image side, a first lens L1 with a positive refractive power, a stop 10, a second lens L2 with a negative refractive power, a third lens L3 with a positive refractive power, a fourth lens L4 with a positive refractive power, an infrared band-pass filter 30, and an imaging surface 50.

The first lens L1 is made of plastic and has an object-side surface S1 and an image-side surface S2. The object-side surface S1 is convex both near an optical axis and at the circumference. The image-side surface S2 is concave near the optical axis and convex at the circumference.

The second lens L2 is made of plastic and has an object-side surface S3 and an image-side surface S4. The object-side surface S3 is concave both near the optical axis and at the circumference. The image-side surface S4 is convex both near the optical axis and at the circumference.

The third lens L3 is made of plastic and has an object-side surface S5 and an image-side surface S6. The object-side surface S5 is concave both near the optical axis and at the circumference. The image-side surface S6 is convex near the optical axis and concave at the circumference.

The fourth lens L4 is made of plastic and has an object-side surface S7 and an image-side surface S8. The object-side surface S7 is convex near the optical axis and concave at the circumference. The image-side surface S8 is concave near the optical axis and convex at the circumference.

In this embodiment, TTL=2.63 mm; FOV=86.36°, tan(FOV/2)=0.938; FNO=1.16; CT2=0.209, CT3=0.294; CT2/CT3=0.711; R5=−3.523, R6=−3.707, R5/R6=0.950; R7=−1.162, R8=−1.226, R7/R8=0.948; R10=0.796, f=1.7, R10/f=0.468; f1=2.62, f23=55.9, f1/f23=0.047.

In this embodiment, the optical imaging system 100 satisfies conditions shown in Table 9 and Table 10 below.

TABLE 9
Fifth embodiment
f = 1.7 mm, FNO = 1.16, FOV = 86.36°, TTL = 2.63 mm

| Surface | Surface | Surface | Y | | | Refractive | Abbe | Focal |
|---|---|---|---|---|---|---|---|---|
| number | name | type | radius | Thickness | Material | index | number | length |
| Object | | spheric | Infinity | 1030.33 | | | | |
| side | | | | | | | | |
| surface | | | | | | | | |
| S1 | First lens | aspheric | 1.308 | 0.434 | plastic | 1.651 | 21.520 | 2.62 |
| S2 | | aspheric | 5.660 | 0.000 | | | | |
| Stop | | | Infinity | 0.308 | | | | |
| S3 | Second | aspheric | −3.523 | 0.209 | plastic | 1.660 | 20.400 | −200.49 |
| S4 | lens | aspheric | −3.707 | 0.100 | | | | |
| S5 | Third lens | aspheric | −1.162 | 0.294 | plastic | 1.660 | 20.400 | 45.67 |
| S6 | | aspheric | −1.226 | 0.100 | | | | |
| S7 | Fourth | aspheric | 0.674 | 0.307 | plastic | 1.660 | 20.400 | 3.51 |
| S8 | lens | aspheric | 0.796 | 0.261 | | | | |
| 31 | Infrared | spheric | Infinity | 0.216 | glass | 1.517 | 64.167 | |
| 32 | band-pass | spheric | Infinity | 0.401 | | | | |
| | filter | | | | | | | |
| Imaging | | spheric | Infinity | 0.000 | | | | |
| surface | | | | | | | | |

Note:
an IR wavelength of 940 nm is used as a reference wavelength during the test procedure of the embodiment of the disclosure

TABLE 10
Aspheric coefficients of the fifth embodiment

| Surface | | | | | | | | |
|---|---|---|---|---|---|---|---|---|
| number | S1 | S2 | S3 | S4 | S5 | S6 | S7 | S8 |
| K | −8.8167E−01 | −5.1618E+01 | −9.9000E−01 | 5.8906E+00 | 2.8393E−01 | −2.5002E+01 | −4.2708E+00 | −1.4750E+00 |
| A4 | −2.5525E−01 | 1.6732E−01 | −6.6892E−01 | −1.8905E+00 | 2.6221E−01 | −2.8253E+00 | −6.1352E−01 | −5.0591E−01 |
| A6 | 3.0272E+00 | −5.6327E+00 | −6.6310E+00 | 2.8463E+01 | 1.2076E+01 | 2.7838E+01 | 4.8188E+00 | 1.0154E+00 |
| A8 | −1.6802E+01 | 6.9138E+01 | 1.2065E+02 | −2.6985E+02 | −1.2275E+02 | −1.9466E+02 | −2.0332E+01 | −3.1148E+00 |
| A10 | 3.6053E+01 | −5.1812E+02 | −1.0944E+03 | 1.5476E+03 | 6.4860E+02 | 8.8723E+02 | 4.6352E+01 | 5.8684E+00 |
| Al2 | 4.7717E+01 | 2.3805E+03 | 5.7811E+03 | −5.6484E+03 | −2.1463E+03 | −2.6098E+03 | −6.3272E+01 | −6.4481E+00 |
| A14 | −4.3515E+02 | −6.7834E+03 | −1.8440E+04 | 1.3167E+04 | 4.5549E+03 | 4.8959E+03 | 5.3185E+01 | 4.1856E+00 |
| A16 | 9.6391E+02 | 1.1665E+04 | 3.5145E+04 | −1.8860E+04 | −5.9534E+03 | −5.6359E+03 | −2.6926E+01 | −1.5676E+00 |
| A18 | −9.6549E+02 | −1.1074E+04 | −3.6896E+04 | 1.5036E+04 | 4.3206E+03 | 3.6224E+03 | 7.5238E+00 | 3.0949E−01 |
| A20 | 3.7518E+02 | 4.4524E+03 | 1.6408E+04 | −5.0876E+03 | −1.3241E+03 | −9.9467E+02 | −8.9125E−01 | −2.4579E−02 |

Table 10 shows the aspheric coefficients of the fifth embodiment, where k represents conic coefficients of respective surfaces, and A4-A20 represent the aspheric coefficients of orders 4-20 of respective surfaces.

As can be seen from FIG. 5B, the optical imaging system 100 of the embodiment has a relatively high resolution while satisfying a compact size.

### Sixth Embodiment

Referring to FIG. 6A and FIG. 6B, FIG. 6A is a schematic structural diagram of an optical imaging system 100 according to the fourth embodiment, and FIG. 6B illustrates from left to right the spherical aberration curve, the astigmatic curve, and the distortion curve of the third embodiment of the disclosure. As can be seen from FIG. 6A, the optical imaging system 100 of the sixth embodiment includes, from an object side to an image side, a first lens L1 with a positive refractive power, a stop 10, a second lens L2 with a positive refractive power, a third lens L3 with a positive refractive power, a fourth lens L4 with a negative refractive power, an infrared band-pass filter 30, and an imaging surface 50.

The first lens L1 is made of plastic and has an object-side surface S1 and an image-side surface S2. The object-side surface S1 is convex both near an optical axis and at the circumference. The image-side surface S2 is concave near the optical axis and convex at the circumference.

The second lens L2 is made of plastic and has an object-side surface S3 and an image-side surface S4. The object-side surface S3 is convex near the optical axis and concave at the circumference. The image-side surface S4 is concave near the optical axis and convex at the circumference.

The third lens L3 is made of plastic and has an object-side surface S5 and an image-side surface S6. The object-side surface S5 is concave both near the optical axis and at the circumference. The image-side surface S6 is convex near the optical axis and concave at the circumference.

The fourth lens L4 is made of plastic and has an object-side surface S7 and an image-side surface S8. The object-side surface S7 is convex near the optical axis and concave at the circumference. The image-side surface S8 is concave near the optical axis and convex at the circumference.

In this embodiment, TTL=2.60 mm; FOV=78°, tan(FOV/2)=0.81; FNO=1.40; CT2=0.21, CT3=0.307; CT2/CT3=0.684; R5=11.062, R6=116.012, R5/R6=0.095; R7=−0.95, R8=−0.887, R7/R8=1.071; R=0.785, f=1.831, R10/f=0.429; f1=2.5, f23=5.727, f1/f23=0.437.

In this embodiment, the optical imaging system 100 satisfies conditions shown in Table 11 and Table 12 below.

TABLE 11
Sixth embodiment
f = 1.831 mm, FNO = 1.4, FOV = 78° , TTL = 2.6 mm

| Surface | Surface | Surface | Y | | | Refractive | Abbe | Focal |
|---|---|---|---|---|---|---|---|---|
| number | name | type | radius | Thickness | Material | index | number | length |
| Object | | spheric | Infinity | 1000.00 | | | | |
| side | | | | | | | | |
| surface | | | | | | | | |
| S1 | First lens | aspheric | 1.163 | 0.420 | plastic | 1.640 | 23.530 | 2.50 |
| S2 | | aspheric | 4.098 | 0.007 | | | | |
| Stop | | | Infinity | 0.274 | | | | |
| S3 | Second | aspheric | 11.062 | 0.210 | plastic | 1.661 | 20.370 | 19.26 |
| S4 | lens | aspheric | 116.012 | 0.104 | | | | |
| S5 | Third lens | aspheric | −0.950 | 0.307 | plastic | 1.640 | 23.530 | 7.62 |
| S6 | | aspheric | −0.887 | 0.100 | | | | |
| S7 | Fourth | aspheric | 0.923 | 0.357 | plastic | 1.640 | 23.530 | −523.93 |
| S8 | lens | aspheric | 0.785 | 0.221 | | | | |
| 31 | Infrared | spheric | Infinity | 0.210 | glass | 1.517 | 64.167 | |
| 32 | band-pass | spheric | Infinity | 0.390 | | | | |
| | filter | | | | | | | |
| Imaging | | spheric | Infinity | 0.000 | | | | |
| surface | | | | | | | | |

Note:
an IR wavelength of 940 nm is used as a reference wavelength during the test procedure of the embodiment of the disclosure

TABLE 12
Aspheric coefficients of the sixth embodiment

| Surface | | | | | | | | |
|---|---|---|---|---|---|---|---|---|
| number | S1 | S2 | S3 | S4 | S5 | S6 | S7 | S8 |
| K | −1.1859E+00 | −8.7877E+01 | 9.9000E+01 | −9.9000E+01 | 6.5948E−02 | −2.5149E+01 | −1.2145E+01 | −2.3187E+00 |
| A4 | −3.4297E−01 | 1.9124E−02 | −1.5100E+00 | −9.9514E−01 | 2.0720E+00 | −4.2417E+00 | −2.3830E−01 | −8.7021E−01 |
| A6 | 6.9132E+00 | −1.1462E−01 | 2.2431E+01 | 1.1754E+01 | −2.6007E+01 | 4.1461E+01 | 2.5409E−01 | 1.6701E+00 |
| A8 | −7.2346E+01 | −2.7792E+01 | −3.0681E+02 | −9.7156E+01 | 2.9977E+02 | −2.9860E+02 | −2.4709E+00 | −2.5636E+00 |
| A10 | 4.4905E+02 | 4.0280E+02 | 2.3715E+03 | 4.7060E+02 | −2.1073E+03 | 1.4935E+03 | 9.4412E+00 | 2.8901E+00 |
| Al2 | −1.7505E+03 | −2.9055E+03 | −1.1193E+04 | −1.6176E+03 | 9.0417E+03 | −4.9850E+03 | −1.8416E+01 | −2.4358E+00 |
| A14 | 4.3009E+03 | 1.1870E+04 | 3.2441E+04 | 3.9843E+03 | −2.4182E+04 | 1.0831E+04 | 2.0409E+01 | 1.5420E+00 |
| A16 | −6.4817E+03 | −2.7875E+04 | −5.4990E+04 | −5.8458E+03 | 4.0099E+04 | −1.4620E+04 | −1.2917E+01 | −7.0606E−01 |
| A18 | 5.4692E+03 | 3.5113E+04 | 4.8269E+04 | 3.6246E+03 | −3.8360E+04 | 1.1091E+04 | 4.3555E+00 | 2.0346E−01 |
| A20 | −1.9797E+03 | −1.8398E+04 | −1.5724E+04 | 0.0000E+00 | 1.6345E+04 | −3.6034E+03 | −6.0859E−01 | −2.6503E−02 |

Table 12 shows the aspheric coefficients of the sixth embodiment, where k represents conic coefficients of respective surfaces, and A4-A20 represent the aspheric coefficients of orders 4-20 of respective surfaces.

As can be seen from FIG. 6A and FIG. 6B, the optical imaging system 100 of the embodiment has relatively high image quality while satisfying a compact size.

Referring to FIG. 7, the present disclosure further provides an image capturing apparatus 200, the apparatus including the optical imaging system 100 of the disclosure and a photosensitive element 210. The photosensitive element 210 is located at the image side of the optical imaging system 100.

The photosensitive element 210 may be a charge coupled device (CCD) or a complementary metal-oxide semiconductor sensor (CMOS sensor).

The image capturing apparatus 200 of the disclosure has a wider focus range and a higher image quality while satisfying a compact size.

For other features of the image capturing apparatus 200, reference may be made to the description above, which will not be repeated herein.

Referring to FIG. 8, the disclosure further provides an electronic device 300, which includes a main body 310 and the image capturing apparatus 200 of the disclosure. The image capturing apparatus 200 is installed on the main body 310.

The electronic device 300 of this disclosure includes but is not limited to an in-vehicle camera, a computer, a laptop, a tablet, a mobile phone, a camera, a smart bracelet, a smart watch, smart glasses, an e-book reader, a portable multimedia player, a mobile medical device, etc.

The electronic device 300 has a camera with a small thickness, which facilitates to reduce a size of the electronic device 300.

The above are only specific implementations of this disclosure, but the scope of protection of this disclosure is not limited to this. Any person skilled in the art can easily think of various equivalent modifications or replacements within the technical scope disclosed in this disclosure. These modifications or replacements shall be covered within the scope of protection of this disclosure. Therefore, the protection scope of this disclosure shall be subject to the protection scope of the claims.

What is claimed is:

1. An optical imaging system comprising, in order from an object side to an image side:
a first lens with a positive refractive power;
a second lens with a refractive power;
a third lens with a refractive power; and
a fourth lens with a refractive power;
wherein the optical imaging system satisfies the following expression:
TTL≤2.644 mm;
wherein TTL represents a distance from an object-side surface of the first lens to an imaging surface along an optical axis.

2. The optical imaging system of claim 1, wherein the first lens has an object-side surface which is convex near the optical axis and an image-side surface which is concave near the optical axis.

3. The optical imaging system of claim 1, wherein the third lens has an object-side surface which is concave near the optical axis and an image-side surface which is convex near the optical axis.

4. The optical imaging system of claim 1, wherein the fourth lens has an object-side surface which is convex near the optical axis and an image-side surface which is concave near the optical axis.

5. The optical imaging system of claim 1, wherein at least one of an object-side surface or an image-side surface of the fourth lens has at least one inflection point.

6. The optical imaging system of claim 1, wherein the optical imaging system satisfies the following expression:
0.8<tan(FOV/2)<1.0;
wherein FOV represents a maximum angle of view of the optical imaging system.

7. The optical imaging system of claim 1, wherein the optical imaging system satisfies the following expression:
FNO≤1.6;
wherein FNO represents an F-number of the optical imaging system.

8. The optical imaging system of claim 7, wherein the optical imaging system satisfies the following expression:
FNO≤1.3;
wherein FNO represents the F-number of the optical imaging system.

9. The optical imaging system of claim 1, wherein the optical imaging system satisfies the following expressions:
19<Vd1<25;
19<Vd2<25;
19<Vd3<25;
19<Vd4<25;
wherein Vd1 represents the Abbe number of the first lens, Vd2 represents the Abbe number of the second lens, Vd3 represents the Abbe number of the third lens, and Vd4 represents the Abbe number of the fourth lens.

10. The optical imaging system of claim 1, wherein the optical imaging system satisfies the following expression:
0.5<CT2/CT3<1.5;
wherein CT2 represents a center thickness of the second lens, and CT3 represents a center thickness of the third lens.

11. The optical imaging system of claim 1, wherein the optical imaging system satisfies the following expression:
0<R5/R6<2.2;
wherein R5 represents a radius of curvature of an object-side surface of the second lens at the optical axis, and R6 represents a radius of curvature of an image-side surface of the second lens at the optical axis.

12. The optical imaging system of claim 1, wherein the optical imaging system satisfies the following expression:
0.18<R7/R8<1.1;
wherein R7 represents a radius of curvature of an object-side surface of the third lens at the optical axis, and R8 represents a radius of curvature of an image-side surface of the third lens at the optical axis.

13. The optical imaging system of claim 1, wherein the optical imaging system satisfies the following expression:
0.4<R10/f<0.8;
wherein R10 represents a radius of curvature of an image-side surface of the fourth lens at the optical axis, and f represents an effective focal length of the optical imaging system.

14. The optical imaging system of any of claim 1, wherein the optical imaging system satisfies the following expression:
−1<f1/f23<0.5;
wherein f1 represents an effective focal length of the first lens, and f23 represents a composite focal length of the second lens and the third lens.

15. An image capturing apparatus, comprising:
an optical imaging system comprising, in order from an object side to an image side:
a first lens with a positive refractive power;
a second lens with a refractive power;
a third lens with a refractive power; and
a fourth lens with a refractive power;
wherein the optical imaging system satisfies the following expression:
TTL≤2.644 mm;
wherein TTL represents a distance from an object-side surface of the first lens to an imaging surface along an optical axis; and
a photosensitive element disposed at the image side of the optical imaging system.

16. The image capturing apparatus of claim 15, wherein the first lens has an object-side surface which is convex near the optical axis and an image-side surface which is concave near the optical axis.

17. The image capturing apparatus of claim 15, wherein the third lens has an object-side surface which is concave near the optical axis and an image-side surface which is convex near the optical axis.

18. The image capturing apparatus of claim 15, wherein the fourth lens has an object-side surface which is convex near the optical axis and an image-side surface which is concave near the optical axis.

19. The image capturing apparatus of claim 15, wherein at least one of an object-side surface or an image-side surface of the fourth lens has at least one inflection point.

20. An electronic device, comprising:
a main body; and
an image capturing apparatus, the image capturing apparatus being installed on the main body, the image capturing apparatus comprising an optical imaging system and a photosensitive element disposed at an image side of the optical imaging system, wherein the optical imaging system comprises, in order from an object side to the image side:
a first lens with a positive refractive power;
a second lens with a refractive power;
a third lens with a refractive power; and
a fourth lens with a refractive power;
wherein the optical imaging system satisfies the following expression:
TTL≤2.644 mm;
wherein TTL represents a distance from an object-side surface of the first lens to an imaging surface along an optical axis.
